(19) United States
(12) Patent Application Publication
(10) Pub. No.: US 2005/0028219 A1
(43) Pub. Date: Feb. 3, 2005

(54) System and method for multicasting events of interest

(76) Inventors: Asaf Atzmon, Ra'anana (IL); Yosef Zohar Ariely, Ramat Hasharon (IL); Dror Golan, ShoHam (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/632,942

(22) Filed: Jul. 31, 2003

(51) Int. Cl. H04N 7/16; H04H 9/00; H04N 7/173

(52) U.S. Cl. 725/116; 725/86; 725/125; 725/89; 725/22

(57) ABSTRACT

A system and method for multicasting an event of interest, the method includes detecting an occurrence of an event of interest within a received media stream; and multicasting the event of interest within one or more media stream of interest.

### FIELD OF THE INVENTION

The invention related to transmission of media content over access networks.

### BACKGROUND OF THE INVENTION

Time shifted television

Time shifted television enables a client to view a program at a time that differs from the time that program is broadcast. A client may require to pause a live broadcast program due to various reasons (for example, because he is suddenly engaged in another activity), and then to resume watching the program from the same place. A client may also request an instant replay, thus receiving a delayed program segment.

A client may request an instant replay for various reasons, and while viewing programs of different types. Typically, an instant replay request is related to sport events (for example, in response to a touchdown, a goal, or in response to a controversial ruling).

There are various techniques that enable time shifted television. A first technique is based upon upgrading the client device. Vendors such as Tivo Inc. provide clients with DVR's that record selected programs on a hard drive, thus enabling the client to watch the recorded program whenever they want to. This solution is relatively costly from a client point of view.

Another solution focuses on the content that is broadcast to the clients. A program is broadcast over broadcast/multicast channels. Once a request to perform a time shift is detected, a unicast time shifted channel is sent to the client. Minerva Networks Inc. is a vendor that provides systems that are capable of receiving media streams from satellite, terrestrial networks and converting then into multicast and unicast media streams. The unicast media streams are transmitted in response to pause requests, instant replay requests and the like.

U.S. patent application serial number 20020124258 of Fritsch, titled “Method and system for providing time-shifted delivery of live media programs” describes methods and delivery centers for delivering programs to viewers. Programs are received at a media delivery center and are converted to IP packets. The IP packets are then broadcast to client devices and are also buffered, to enable unicast transmission of these packets in response to a client request to receive a unicast time shifted program. Accordingly, once a client requests an instant replay and/or a delayed program (for example, resulting from a pausing period) that program is unicast to that client device.

Compression Schemes

Digital video must be extensively compressed prior to transmission and storage, as each picture includes multiple pixels, and each pixel has three color-difference multi-bit values.

Standard compression schemes (such as the MPEG compression standards, JPEG, H.263 and others) utilize multiple compression techniques to achieve a very high compression rate.

JPEG is used to compress still pictures, MJPG or moving JPEG is used to compress a sequence of still pictures. Media streams are compressed by MPEG.

MPEG is complex and defines strict timing requirements upon the decoding and displaying of pictures. An MPEG compliant stream must be provided to an MPEG decoder and presented in a very precise manner. Timing deviations may result in severe degradation of the decoder images.

Set Top Boxes

The set top box is a very common client device. There are various types of access networks and accordingly there are different types of corresponding set top boxes which are connected to the access networks and capable of receiving media streams as well as information. The most common set top boxes are connected to Hybrid Fiber Coax (HFC) access networks. These set top boxes are manufactures by many vendors, such as Scientific Atlanta and Motorola. Another type is the internet protocol (IP) set top box that is connected to IP based access network.

A prior art set top box software platform includes various components such as a single MPEG decoder (and a corresponding MPEG decoder software driver), browsing software, TV tuner (and a corresponding TV tuner driver). These components facilitate displaying both an analog video stream as well as IP conveyed video stream. These components may also be utilized for displaying both video streams, for example from Video On Demand sources, as well as Internet browsing materials. In either case only one video stream can be processed by the MPEG decoder.

It is known in the art that MPEG is a complex (and accordingly costly) process. Typically, set top boxes include a single MPEG hardware decoder. MPEG software decoders are known in the art but require costly hardware, thus dramatically increasing the cost of set top box.

A prior art set top box may allow the viewer to handle one MPEG compliant video stream at a time. This limitation has many implications. For example, assuming that an end user views a first MPEG encoded program, but would like to know the content of a second MPEG encoded program. This requires switching between the first to the second MPEG encoded program. In a typical scenario an end user wants to skip an advertisement that is embedded within the first MPEG compliant program. He will switch to the other program and try to guess when the first advertisement ends. This may amount in multiple program switching and missing the end of the advertisement.

JAVA, HTML

Internet browsers are able to fetch images from many different web servers onto a single web page. This allows adding live images to web pages in a very easy manner. The images are refreshed at a predefined refresh rate. Set top box with browser capabilities are able to receive images from two distinct sources (MPEG and analog TV feed, MPEG and XMP) and to alpha blend them. Alpha blending is a technique for generating a superposition of two images, whereas the “upper” image may have a transparency value (alpha factor) that ranges between zero (totally transparent “upper” image) to one (totally oblique “upper” layer).

### SUMMARY OF THE INVENTION

The invention provides a method for providing an event of interest to multiple client devices. The method starts by detecting an event of interest. The detection may be responsive to the content of received media streams. The detection can be done by viewing the media streams and determining that then include events of interest.

The invention provides a system and method that reduces the load of a television network.

According to an embodiment of the invention the media streams are broadcast via multicast channels to multiple client devices whereas the detection may be executed in parallel to said multicasting.

According to various embodiments of the invention an event of interest may be detected by one or more of the following manners, and even by a combination of said manners: (i) monitoring the amount of time shifted television requests (such as pause, rewind, instant replay and the like) associated with a certain media stream, whereas the requests are within a predefined time window, (ii) monitoring media distribution resource allocation, such as processing power, (iii) viewing broadcasted media streams and determining, according to the broadcast content, that an event of interest occurred, (iv) processing the media stream to locate sections that are characterized by certain predefine d criterion, such as a certain amount of noise within predefined frequency range, a certain amount of noise, and the like. The processing may also include image processing. The image processing may be tuned to locate a predefined logo or graphics that are displayed once a certain event of interest is broadcast. For example, when a goal is scored many channels display a “GOAL” graphics on the screen. In other cases such an image may be displayed within the stadium in which the sport events takes place (for example an image of clapping hands). These images may be detected to identify the occurrence of an event of interest.

According to an embodiment of the invention the channels and/or programs that are subjected to the detection step may be selected in advance.

The events of interest may be detected almost in real time, but may also be determined in advance. The latter involves determining a timing window of a program that has to be dealt as an event of interest. An event of interest may be determined by “off-line” processing of media stream. For example, a program that is not a live program can be processed before being broadcast to detect events of interest that may be incorporated within media streams that include events of interest. These media streams may be broadcast in concurrence with the program.

The method may include a step of generating one or more media streams that include multiple events of interest (e.g. “media streams of interest”). Each media stream of interest is then multicast.

The media stream of interest may be available to all client devices or to a subset of the client devices, in response to client criterion. For example, the multicast of event of interest may be provided to a client device upon payment of fees by the client.

A certain media stream of interest may include events of interest that: (i) occurred during a predefined period, and/or (ii) are associated with a certain channel or program, and/or (iii) of a certain type, such as sport related events, news type events and the like.

The content of a media stream of interest may be updated/refreshed in various manners in response to update parameters, such as overall media stream of interest length, timing of events of interest within the media stream of interest.

The content of media stream of interest may be responsive to client actions or feedback. Client actions refer to requests for instant replay. For example, event of interest that are requested (instant replay request) by more clients remain in the media stream of interest while other events of interest, that were less popular are removed.

Additionally or alternatively, clients may be allowed to provide feedback about the content of the media streams of interest. The feedback received from client devices is processed to determine how to refresh the media stream of interest.

According to an embodiment of the invention once an event of interest is detected and included within a multicast media stream of interest, the method does not unicast the original media stream in response to a time shifted television request.

According to another embodiment once a event of interest is included within a multicast media stream of interest the clients which started to receive a unicast of the original media streams are switched to the multicast stream of interest, but this is not necessarily so.

According to an embodiment of the invention the method further includes a step of notifying clients that an event of interest occurred. The notification can be implemented in various manners, such as by sending a notification message over a downstream channel. This channel may be monitored by the client device in various manners, such as constant monitoring, periodical monitoring (polling) or other manners known in the art. Conveniently, this downstream channel differs (at least logically) from the downstream channel that is used for transmitting media streams. For example, a client may have a client device that includes multiple ports, one for receiving media streams and the other for receiving data. This is not necessarily so and a single port may be used, along with time division techniques.

The client may be notified by a textual notification message, an image and even by a sequence of images representative of the event of interest. The sequence may appear within a picture in picture configuration. The client may also receive an audio signal or message notifying him about the occurrence of the event of interest.

The method can define rules for notifying the client about an occurrence of an event of interest. The client can be notified about an event of interest that occurred in a channel that differs from the channel that he is currently viewing. The client may define a set of rules regarding how to be notified and in what cases, although the method can respond to these rules or process multiple requests from multiple client to define how to notify multiple clients.

According to an embodiment of the invention a client device receives a first program, which is usually multicast to the client device and to a group of client devices. Once an event of interest occurs, and according to notification rules, the client receives a notification. If the client selects to change a channel, in order to view the event of interest, he leaves the first multicast group and enters a second multicast group, said second multicast group receives the media stream of interest that includes the event of interest. In case where more than a single media stream of interest includes the event of interest, the client may select between said streams.

According to another embodiment of the invention once a media stream is multicast clients that viewed unicast that included this media stream of interest are seamlessly switched to receive the multicast.

According to an embodiment of the invention a client device receives two types of media stream of interest —the first substantially includes a single event of interest that is repeatedly broadcast, while a second media stream of interest includes multiple events of interest, such as events that originated from a single show, program or sport event. The first media steam of interest has a short life span (can be only few minutes), while the second media stream of interest may have a much longer life span (can be broadcast for a whole day and can even be stored as a Video On demand media stream). The client may select to view the first and/or the second media stream of interest.

### BRIEF DESCRIPTION OF THE DRAWINGS

Further features and advantages of the invention will be apparent from the description below. The invention is herein described, by way of example only, with reference to the accompanying drawings, wherein:

FIGS. 2 are schematic illustrations of a hardware configuration of systems for multicasting events of interest, and the systems environment, in accordance with embodiments of the invention;

FIGS. 3-4 are graphic illustrations of exemplary interface screens, with accordance with embodiments of the invention;

FIG. 5 is a flow chart diagram of a client device side process, in accordance with an embodiment of the invention; and

FIG. 6 is a flow chart diagram of a television distribution network side process, in accordance with an embodiment of the invention.

### DETAILED DESCRIPTION OF THE DRAWINGS

The inventors made an observation that the transmission of some events may result in multiple instant reply requests and that multicasting these events may improve the television network ability to cope with a large number of substantially simultaneously instant replay requests to review this event.

Referring now to FIG. 1 illustrating a hardware configuration of system 10 and an environment of that system, in accordance with an aspect of the invention.

System 10 is a multimedia platform known as RiGHTv™ of orca interactive Ltd. of Israel. It is noted that other systems may be used to implement the invention.

System 10 includes load balancer 11, multiple cache units 12, multiple internet application servers 14, multiple databases and storage device 22, video server management unit 24, video storage unit 26, digital turnaround devices 28 and IRD units (not shown). The IRD units feed the digital turnaround devices 28. Encoders 30 are connected between analog sources and IP streamers 32. The IP streamers 32 are also connected to the digital turnaround devices 28 and to regional video servers 34.

System 10 is arranged as a dual tier system in which some of its components (such as devices 22-32) are connected to other parts of the system over an IP backbone network. Load balancer 10 and regional video servers 34 are connected to client devices 50 over IP based access networks (such as but not limited to ADSL, VDSL, Ethernet and Fiber access networks).

A client may be equipped with various client devices, such as a personal computer (PC), a set top box (STB), a cellular phone, a Personal Digital Assistant (PDA) as well as other devices. For simplicity of explanation only four client devices are illustrated, whereas usually the amount of client devices is much larger.

System 10 is arranged in a cluster formation but this is not necessarily so.

System 10 is able to receive analog media streams (for example, from video camera 40) and digital video streams (for example, from satellite 42) convert them into IP compliant media streams that are sent to regional video servers and to clients 50. These streams are also sent to video storage unit 26 and/or multiple databases and storage device 22 to be either analyzed for finding events of interest and, alternatively or additionally, to enable other time shifted television operations and/or to facilitate video on demand capabilities. It is noted that some event detection processes (such as image processing based event detection or audio processing based event detection) may be executed at the encoders or digital turnaround units.

According to yet another aspect of the invention the media streams of interest are edited by an operator, via interfaces, whereas the editing process also involves the RIGHTv™ software as well as the video server management unit 24.

The reception of analog media streams and/or digital media streams and conversion to IP compliant streams may involve trans-coding, encoding, de-multiplexing, compression, de-compression, encryption, decryption and the like in manners known in the art. For example, analog media streams may be converted to digital media streams that in turn may be converted to packets, such as IP packets. Digital streams, such as multi program transport stream are de-multiplexed to multiple single program streams that are then packetized to provide IP packets.

It is noted that multiple components of system 10 have processing capabilities. Processes related to events of interest may be executed by more than a single component. Most of the operations related to events of interest were executed by either video server management unit 24 or the Internet application servers 14, but this is not necessarily so.

System 10 may include a single tier, as well as three or more tiers, and can operate at a central configuration as well as a distributed configuration.

Those skilled in the art will readily appreciate that various modifications and changes may be applied to the preferred embodiments of the invention as hereinbefore exemplified without departing from its scope as defined in and by the appended claims.

System 10 has media stream generation capabilities. These capabilities are usually utilized for advertisement insertion and the like, but are also used for creating media stream of interest, in a manner known in the art. The capability of generating a media stream is known in the art and can be found in commercial media servers, such as n4x of nCube Inc., Vision of Bitband Networks Inc.

RiGHTV™ also include a software package that includes a subscriber user interface, a web cache, a run time engine, RiGHTV™_{XVOD} software, RiGHTV™_{XBIP} software, RiGHTV™_{CORE} software and RiGHTv™ integration server.

The RiGHTv™_{XBIP} enables Electronic Programming Guide (EPG) information as well as media streams to be provided to multiple clients, using IP multicast technology. The RIGHTv™_{XVOD} software facilitated video on demand capabilities, including advertisement insertion. The RiGHTv™ integration server allows to interface between the software and various systems such as billing systems, CSR systems and to allow easy integration of new components, such as additional video server, to the system.

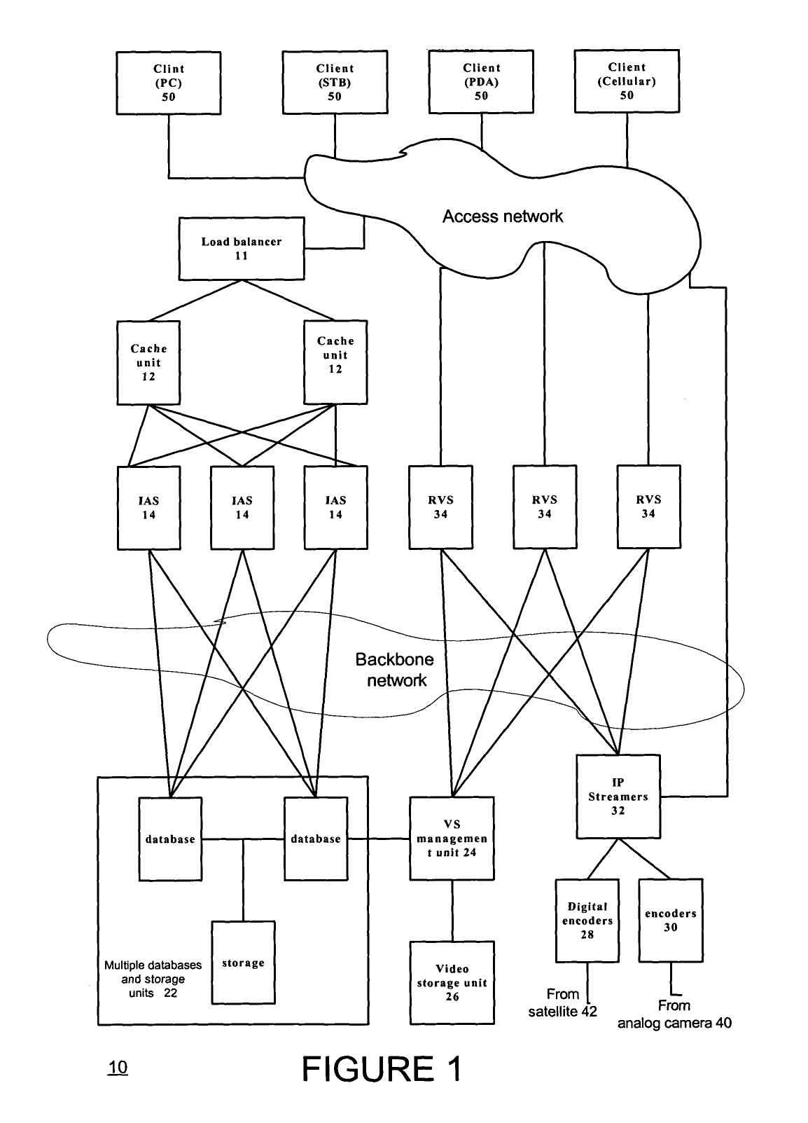

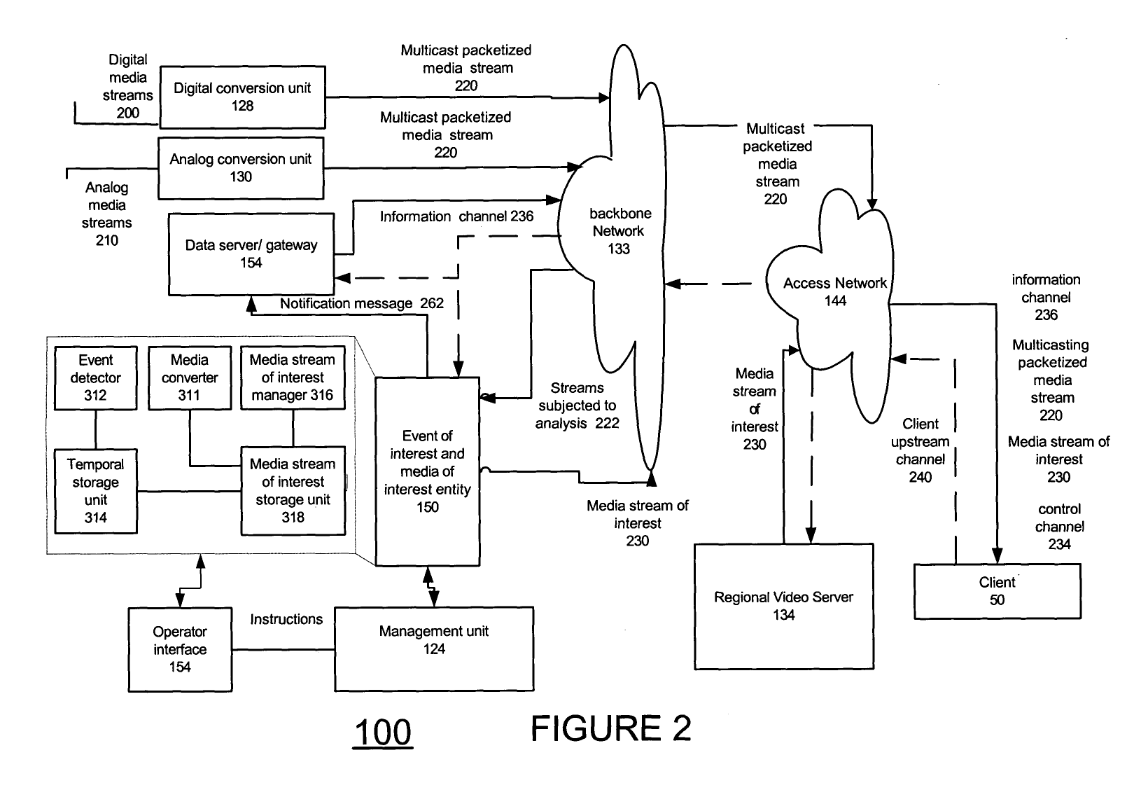

FIG. 2 is a schematic illustration of system 100 for multicasting events of interest, and its environment. FIG. 2 also illustrates some of the signals and/or channels that are exchanges between various entities of system 100 and a client device.

System 100 includes digital conversion unit 128, analog conversion units, data server/gateway 154, event of interest and media of interest unit 150, management unit 124, operator interface 154 and regional video server 134.

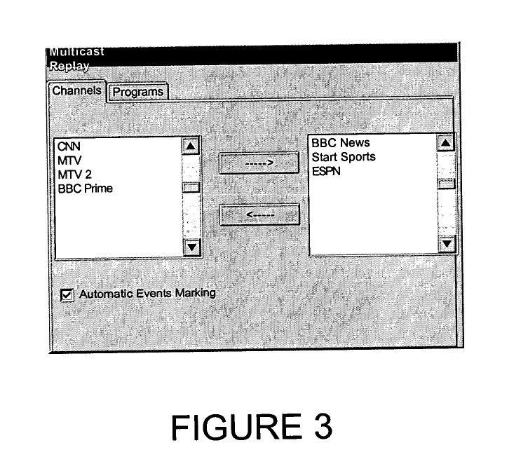

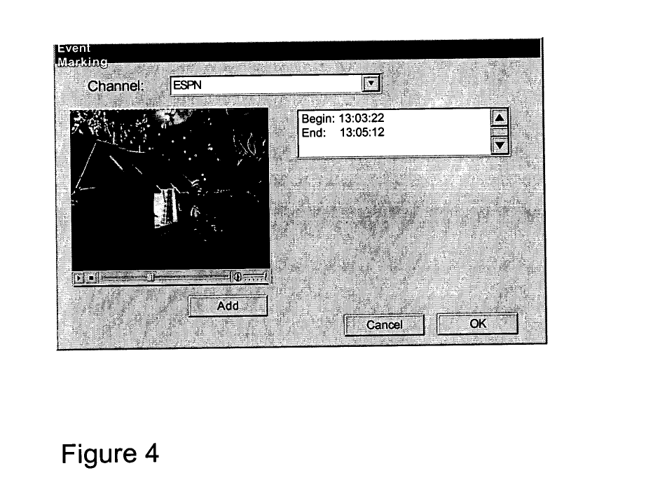

The operator interface enables the operator to define various parameters and/or criteria, such as but not limited to: (i) which received media streams out of the received media streams may include media streams of interest (as illustrated in the exemplary interface screen of FIG. 3), these received media streams are analyzed to locate events of interest, but the events may also be defined as a time window (as illustrated in the exemplary interface screen of FIG. 4); (ii) client criteria (which client devices may be provided with media stream of interest, the quality of media stream of interest to be provided to each client device), (iii) event detection criteria, (iv) update parameters, and (v) the notification rules.

These parameters are fed, via operator interface 154 to management unit 124. Management unit 124 controls multiple units, but for simplicity of illustration is illustrated as being connected only to operator interface 154 and to event of interest and media of interest unit 150.

The client may be notified about an event of interest in various manners. According to various embodiments of the invention a possibility to view a media stream of interest may be illustrated in at least one of the following manners: (i) a symbol, such as an icon, that indicates that a certain event of interest was detected and can be replayed, (ii) a textual message, describing the event of interest, (iii) a snapshot image representative of the event of interest, (iv) a stream of images that represent the event of interest. This stream of images may be provided to the client device in a format that does not require an MPEG decoder, thus enabling a set top box to MPEG decode a media stream while also presenting the stream of images. The stream of images is usually displayed in a picture in picture format.

The event of interest can be replayed by viewing a media stream of interest that only includes that event of interest. The event of interest can be replayed by tuning to a media stream of interest (out of one or more media streams of interest) that also includes other events of interest.

If the event of interest can be viewed in one or more media stream of interest the client can select which media stream of interest to view, although the selection may be done automatically, for example, in response to client behavior pattern or in response to previously determined client viewing parameters.

The client will be able to use a remote control (or other control means) to skip between multicast media streams and multicast media stream of interest, and optionally between a multicast media stream and unicast media stream.

The system may also define a media stream of interest of limited duration. Once the media stream of interest expires, the client device can be switched back automatically to the channel he viewed before tuning to the expired channel. This is facilitated by storing the channel ID before tuning to the now expired media stream of interest.

Referring back to FIG. 2, digital conversion units 128 are able to receive digital media streams 200 and convert them to multicast media streams 220. The conversion may include trans-coding, encryption, de-multiplexing, packetizing and the like.

Analog conversion units 130 are able to receive analog media streams 210 and convert them to multicast media streams 220. The multicast media streams 220 are provided to backbone network 133 that in turn provides these streams to regional video servers 134 or even directly to clients via access network 144. These multicast media streams 220 or a subset (222) of them are provided to event of interest and media interest unit 150 for detecting events of interest.

Backbone network and access network 144 are also capable of exchanging information, such as web content, EPG content an the like over information channel 236, between a client and a data server/getaway 154. Data server/getaway 154 may be connected to other networks, such as the Internet, for exchanging content.

The system may also downstream unicast media streams to a client device (such as time shifted media streams, video on demand media streams and the like) but theses are not illustrated, for clarity of the explanation.

The regional video server 134 is used to relay multicast and unicast media streams received from backbone network 133 to access network 144 and then to client device 50.

According to another embodiment of the invention the regional video server 134 may be connected to a central or local means for event of interest detection and generation capabilities. It may be connected to local units such as units 124, 150, local operator interface, local digital and analog converters as well as local data server/getaway. Such a configuration may improve the response time between the detection of an event of interest and the multicasting of media stream of interest.

The event of interest and media of interest unit 150 includes various units such as event detector 312, temporal storage unit 314, media stream of interest manager 316, media stream of interest storage unit 318 and media converter 311 that are connected to each other.

Event detector 312 detects the occurrence of an event of interest. Event detector 312 detects an event of interest by processing received media streams, by monitoring the system activity (for example by monitoring the load of regional video server 134 or a load of a backbone video server (not shown), by monitoring instant replay requests, and/or by applying event detection criteria, and/or in response to instructions from an operator (for example, “an event of interest will be transmitted during time window X at channel Y”). The event detector can be responsive to inputs from an operator which views the broadcast programs (or at least a subset) and can determine, relatively in real time, when an event of interest occurs.

Event detector 312 may check the state of requests or state of other units of system in various manners, such as polling, but may also be fed by regional video server 134 and/or backbone media server (not shown). A threshold can be set on the amount of streams managed by the regional video server 134 (and/or the backbone video server) and/or the video server computational load. Whenever a threshold is passed an event of interest will be multicast within a media stream of interest.

Event detector 312 may also be connected to other systems for receiving a signal representing the occurrence of an event of interest. Such a system can be an automatic system such as the system described at U.S patent serial number 6414914 that provides multimedia search and indexing for automatic selection of scenes and/or sounds recorded in a media for replay using audio cues. Event detector 312 may use the techniques illustrated in said patent.

The detection process may detect an event of interest after a short delay (DO) from the beginning of that event. This delay may result from client response (asking for instant replay after the event begun), form a time window allocated for detecting multiple instant replay request, and/or from delays associated with the execution of media stream processing steps.

In order to allow the transmission of the entire event of interest, the media streams that may include an event of interest are temporarily stored in temporal storage unit 314 that has enough buffering space to compensate for this delay.

According to another aspect of the invention system 100 also includes storage units (not shown) for allowing time-shifted television (“time shifted” storage units), such as databases of multiple database and storage unit 22 of FIG. 1. The “time shifted” storage units are usually capable of storing a large amount of information, and may compensate for time differences that are much larger than delay D0. The “time shifted” storage units can be used to retrieve the events of interest. A traveling pointer can be used to track the location of events of interest within the “time shifted” storage units, till they exit these storage units. The events of interest may be retrieved by using the “time shifted” storage units but are stored in media stream of interest storage unit 318, thus allowing a multicast of media stream of events even long after the event of interest has occurred.

It is noted that the media stream of interest storage unit 318 may be included within a central video server (not shown).

Media stream of interest manager 316 receives from event detector 312 information that allows him to manage the generation of an event of interest and its inclusion within one or more media stream of interest. The information may include timing information as well as channel address.

Media stream of interest manager 316 sends this information to a video server (such as regional video server 134 or a backbone video server) that in turn is able to generate at least one media stream of interest that includes this event of interest. The address of the media stream of interest as well as the generation and/or update of such a media stream of interest are down-streamed to the client device, for example via control channel 234. This information may also be sent to data server/gateway 134 that in turn may be used to downstream this information to the client device.

According to an aspect of the invention a notification message may be in the form of a stream of images, formatted in a manner such to allow their presentation without decoding by a dedicated decoder, such as an MPEG decoder).

This may be implemented by media converter 311 being capable of receiving digital media streams and to convert them to a stream of images (such as an MJPEG stream of images), that in turn may be processed by the client device by means other than the decoder (these means may include browsing means). Multiple streams of images can be simultaneously displayed, as well as being displayed in parallel to the display of media streams that are decoder by a decoder, information such as EPG and the like. These streams may have a relatively high quality, especially when the refresh rate exceeds few Hertz.

Media converter 311 may receive an analog feed and convert it into such as stream of images. Such a conversion can be executed by servers that execute software packages such as Camserv.

According to another embodiment of the invention a stream of images (though in a much lower refresh rate) may be provided from an IP streamer. Streamers having a limited capability of providing are known in the art. One being the TT7116 IP streamer of Tandberg television that is capable of performing content extraction for an XML output. It can be done in a refresh rate of one image per second. If there are N different media stream the refresh rate of each image is 1 per N seconds. The Tandberg television iTTV system allows a display both EPG and thumbnails from transport streams.

Media stream of interest maybe provided to the client device via a backbone video server an/or by a regional video server. The video server may maintain multiple streams of interest that include the event of interest, one may include only the event of interest.

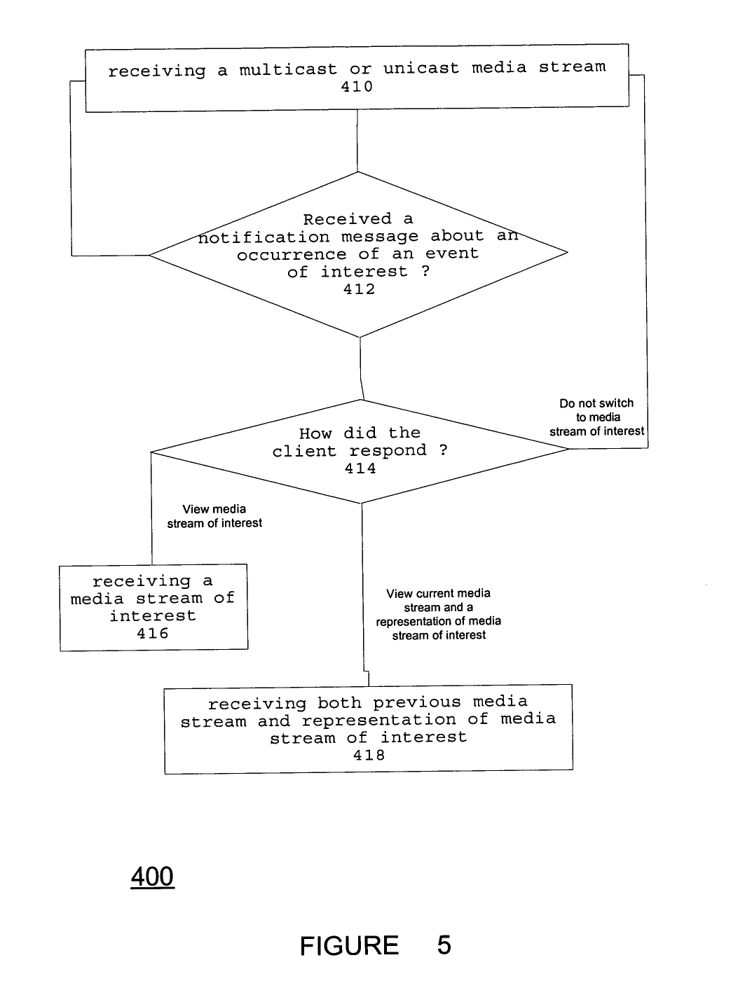

FIG. 5 is a flow chart of a client side process 400, in accordance to an embodiment of the invention.

It is assumed, for simplicity of explanation, that the client device receives a single media of interest that includes the event of interest. In the case of multiples streams of interest the client also can select between the relevant media stream of interest.

Process 400 starts by a step 410 of receiving a multicast or unicast media stream. The multicast or unicast media streams may be a live program, a time shifted program, and the like.

Step 410 is followed by step 412 of determining whether a notification message about an occurrence of an event of interest was received. The notification message is transmitted to the client device according to notification rules that determine which client devices may receive the notification and what is the format of the notification message. The notification message includes the multicast address of the media stream of interest, thus allowing the client device to receive the media stream on interest if the client chooses so.

If the answer is negative (no notification message was received) the process jumps to step 410. Else, step 412 is followed by step 414 of waiting to receive a response from the client (usually via a remote control) and determining what was the client response.

The client may respond by choosing not to switch to the media stream of interest. In such a case step 414 is followed by step 410.

The client may select to switch to the media stream of interest. In such a case step 414 is followed by step 416 of receiving the media stream of interest. Step 416 usually includes storing attributes relating to the previous viewed media stream (such as timing information, channel Id or IP address) to enable the client to resume to that point after viewing the media stream of interest. If the client device previously received a multicast channel he leaves the group of client devices that received that channel. The departure process may require the client device to act (for example, by upstream transmitting a leaving message to the network), but this is not necessarily so. Step 416 also includes a step of joining a new multicast group that receives the media stream of interest. The events of interest are repeatedly broadcast. It is noted that the client may also select to continue receiving the previous multicast or unicast media stream and in addition to receive a representation of a media stream of interest. In such a case step 414 is followed by step 418 of receiving both, while the media stream of interest may be displayed in a picture in picture format. It is noted that the client may also choose to view the media stream of interest and a representation of the previously received multicast or unicast stream or even to view more than a single media stream of interest in a picture in picture format.

The representation of the media stream is displayed after that media stream is converted to a format that does not require decoding. It is noted that client devices that include multiple decoders (or have a software decoder capable of decoding multiple media streams) may display more than a single media stream without the conversion.

The client device side process 400 allows various time shifted television operations, such as pause, rewind and the like. According to an embodiment of the invention the time shifted television operations are monitored to indicate the occurrence of an event of interest. According to another embodiment of the invention once a media stream of interest that includes certain event of interest is multicast, then clients that which to view the event of interest via time shifted television operations will receive the multicast media of interest.

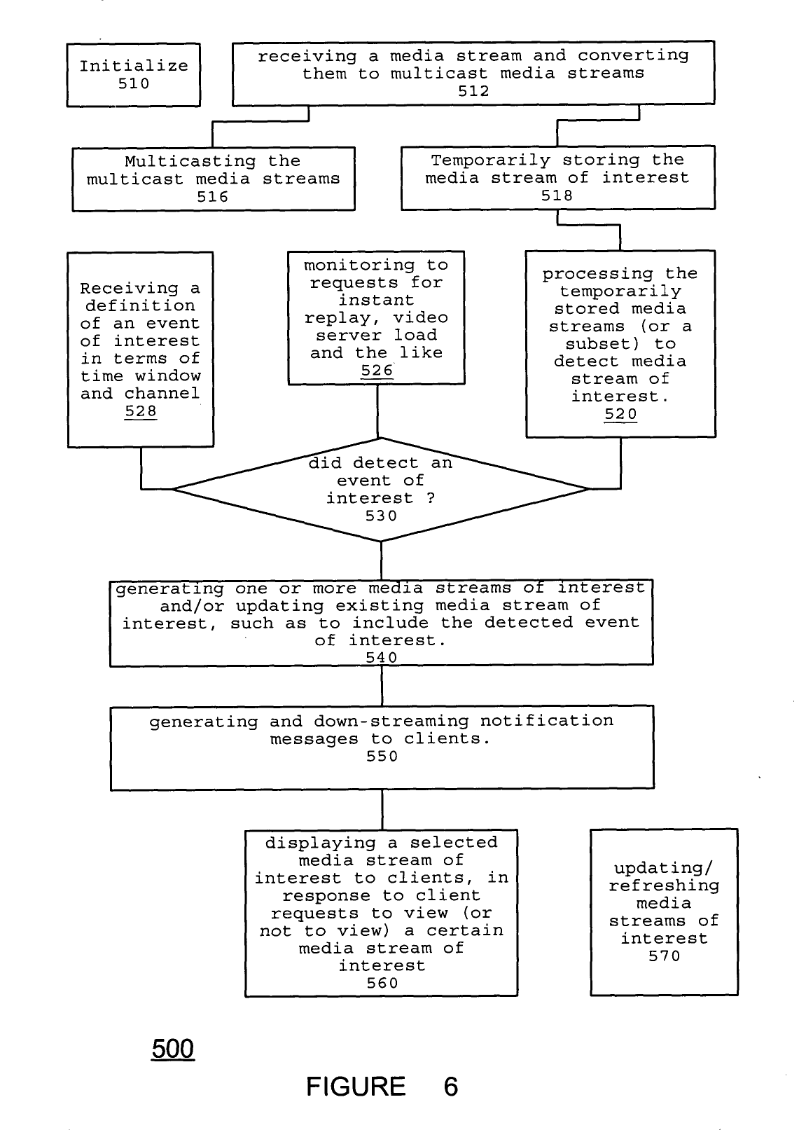

FIG. 6 is a flow chart of a television distribution network side process 500, in accordance to an embodiment of the invention.

Process 500 starts by initialization step 510 of defining multiple parameters and/or criteria such as client criteria, event detection criteria, update parameters, as well a network related parameters, such as mapping between channels and IP multicast addresses.

Step 510 is followed by step 512 of receiving media streams and converting them (or at least some of them) to multicast media streams.

Step 512 is followed by one or more of the following steps and/or a combination of one of more steps: (i) step 516 of multicasting the multicast media streams, (ii) step 518 of temporarily storing the media streams. This may enable time-shifted television as well as generating and/or updating media streams of interest.

Step 518 is followed by step 520 of processing the temporarily stored media streams (or a subset) to detect media stream of interest.

Step 520 is followed by query step 530 of asking whether an event of interest was detected. Query step 530 may receive as input detection signal from other steps, such as step 528 of receiving a definition of an event of interest in terms of a time window and a channel that should be treated as an event of interest. Query step 530 may also receive as input detection signals (from step 526) based upon monitoring to requests for instant replay, video server load and the like. Query step 530 may be responsive to a combination of parameters.

If an event was detected query step 530 is followed by step 540 of generating one or more media streams of interest and/or updating existing media stream of interest, such as to include the detected event of interest.

Step 540 is followed by step 550 of generating and down-streaming notification messages to client devices.

Step 550 is followed by step 560 of displaying a selected media stream of interest to clients, in response to client requests to view (or not to view) a certain media stream of interest.

It is noted that process 500 may include step 570 of updating/refreshing media streams of interest.

It is further noted that method 500 may be modified to enable other time shifted television features, in a manner known in the art.

Those skilled in the art will readily appreciate that various modifications and changes may be applied to the preferred embodiments of the invention as hereinbefore exemplified without departing from its scope as defined in and by the appended claims.

1. A method for multicasting an event of interest, the method comprises the steps of:
detecting an occurrence of an event of interest within a received media stream; and
multicasting at least one media stream of interest that comprises the event of interest.

2. The method of claim 1 further comprising multicasting the received media stream.

3. The method of claim 1 further comprising temporarily storing the received media stream.

4. The method of claim 3 further comprising multicasting the received media stream substantially in parallel with said temporarily storing.

5. The method of claim 1 wherein the step of detecting comprises analyzing the received media to check a compliance of a received media stream segment with an event detect-ion criterion.

6. The method of claim 5 wherein the event detection criterion is responsive to a level of noise signal exceeds a threshold.

7. The method of claim 5 wherein the event detection criterion is responsive to a level of audio signal within predefined frequency.

8. The method of claim 5 wherein the step of detecting comprises monitoring instant replay requests associated with a certain media stream, said requests being generated within a predefined time window.

9. The method of claim 5 wherein the step of detecting comprises monitoring media distribution resource allocation.

10. The method of claim 5 wherein the step of detecting comprises image processing of the received media stream.

11. The method of claim 1 further comprising a step of notifying a client about an occurrence of an event of interest.

12. The method of claim 11 wherein the step of notifying comprising displaying at least one symbol.

13. The method of claim 11 wherein the step of notifying comprises displaying at least one image representative of the event of interest.

14. The method of claim 11 wherein the step of notifying comprises sending to the client information for allowing the client to tune to a multicast media stream of interest.

15. The method of claim 11 wherein the method comprises converting a media stream of interest to a sequence of images representative of the media stream of interest, and displaying the sequence of images, whereas the sequence of images is formatted such as to be processed by a client device unit other than a decoder.

16. The method of claim 15 wherein the sequence of images is displayed at a client device in addition to another media stream.

17. The method of claim 1 wherein a media stream of interest comprises multiple events of interest that occurred during a predefined period.

18. The method of claim 1 wherein a media stream of interest comprises multiple events of interest that are associated with a certain channel or program.

19. The method of claim 1 wherein a media stream of interest comprises multiple events of interest of a certain type.

20. The method of claim 1 further comprising a step of updating media streams of interest according to update parameters.

21. The method of claim 1 further comprising a step of updating a media stream of interest in response to client feedback.

22. The method of claim 1 further comprising a step of updating a media stream of interest in response to client actions.

23. The method of claim 1 further comprising a step of preventing additional multicasting of received media streams that comprise an event of interest once the event of interest is multicast within a media stream of interest.

24. The method of claim 1 further comprising a step of switching a client device to a multicast preventing additional multicasting of received media streams that comprise an event of interest once the event of interest is multicast within a media stream of interest.

25. The method of claim 11 wherein the client is notified about an event of interest according to notification rules, whereas at least one notification rule is defined by the client.

26. The method of claim 1 wherein a client receives a first media stream and is notified about an event of interest that occurred in a second media stream.

27. A system for multicasting an event of interest, the method comprises the steps of:
means for detecting an occurrence of an event of interest within a received media stream; and
means for multicasting at least one media stream of interest that comprises the event of interest.

28. The system of claim 27 further adapted to multicast the received media stream.

29. The system of claim 27 further comprising means for temporarily storing the received media stream.

30. The system of claim 29 further adapted to multicast the received media stream substantially in parallel with said temporarily storing.

31. The system of claim 27 wherein the detecting means analyze the received media to check a compliance of a received media stream segment with an event detection criterion.

32. The system of claim 31 wherein the event detection criterion is responsive to a level of noise signal exceeds a threshold.

33. The system of claim 31 wherein the event detection criterion is responsive to a level of audio signal within predefined frequency.

34. The system of claim 31 wherein the detection means are monitor instant replay requests associated with a certain media stream, said requests being generated within a predefined time window.

35. The system of claim 31 wherein the detection means monitor media distribution resource allocation.

36. The system of claim 31 wherein the detection means image process the received media stream to detect an event of interest.

37. The system of claim 27 further comprising means for notifying a client about an occurrence of an event of interest.

38. The system of claim 37 wherein the client is notified by a display of at least one symbol.

39. The system of claim 37 wherein the client is notified by a display of at least one image representative of the event of interest.

40. The system of claim 37 wherein notification means send to clients information for allowing the client to tune to a multicast media stream of interest.

41. The system of claim 37 wherein the system further comprises means for converting a media stream of interest to a sequence of images representative of the media stream of interest, and whereas the means for notifying are operable to notify a client by a display of a sequence of images, whereas the sequence of images is formatted such as to be processed by a client device unit other than a decoder.

42. The system of claim 41 wherein the sequence of images is displayed in addition to another media stream.

43. The system of claim 37 wherein a media stream of interest comprises multiple events of interest that occurred during a predefined period.

44. The system of claim 37 wherein a media stream of interest comprises multiple events of interest that are associated with a certain channel or program.

45. The system of claim 37 wherein a media stream of interest comprises multiple events of interest of a certain type.

46. The system of claim 37 further comprising means for updating media streams of interest according to update parameters.

47. The system of claim 46 wherein the updating means are responsive to client feedback.

48. The system of claim 46 wherein the updating means are responsive to client actions.

49. The system of claim 27 further adapted to prevent additional multicasting of received media streams that comprise an event of interest once the event of interest is multicast within a media stream of interest.

50. The system of claim 27 further adapted to switch a client device to a multicast preventing additional multicasting of received media streams that comprise an event of interest once the event of interest is multicast within a media stream of interest.

51. The system of claim 37 capable of notifying a client about an event of interest according to notification rules, whereas at least one notification rule is defined by the client.

52. The system of claim 37 capable of notifying a client about an event of interest that occurred in a media stream other than the media stream to which the client device is tuned to.
